(19) United States
(12) Patent Application Publication
(10) Pub. No.: US 2025/0008510 A1
(43) Pub. Date: Jan. 2, 2025

(54) TERMINAL, RADIO COMMUNICATION SYSTEM AND RADIO COMMUNICATION METHOD

(71) Applicant: NTT DOCOMO, INC., Tokyo (JP)

(72) Inventors: Naoya Shibaike, Tokyo (JP); Hiroki Harada, Tokyo (JP); Satoshi Nagata, Tokyo (JP); Qiping Pi, Beijing (CN); Jing Wang, Beijing (CN); Lan Chen, Beijing (CN)

(73) Assignee: NTT DOCOMO, INC., Tokyo (JP)

(21) Appl. No.: 18/707,445

(22) PCT Filed: Nov. 5, 2021
(86) PCT No.: PCT/JP2021/040894

§ 371 Date: May 3, 2024

(51) Int. Cl. H04W 72/1268; H04L 1/1812; H04W 72/231; H04W 72/51

(52) U.S. Cl. CPC H04W 72/1268; H04L 1/1812; H04W 72/231; H04W 72/51

(57) ABSTRACT

A terminal receives a plurality of downlink data channels scheduled by a single downlink control information, and assumes that if any downlink data channel collides with an uplink symbol, the downlink data channel cancelled by the collision is excluded from the specific scheduling.

### TECHNICAL FIELD

The present disclosure relates to a terminal, a radio communication system and a radio communication method supporting multi-PDSCH/PUSCH scheduling.

### BACKGROUND ART

3rd Generation Partnership Project (3GPP) specifies 5th generation mobile communication system (5G, also called New Radio (NR) or Next Generation (NG), further, a succeeding system called Beyond 5G, 5G Evolution or 6G is being specified.

For example, Release-17 of 3GPP supports a frequency band exceeding 52.6 GHz and up to 71 GHz, and one (single) downlink control information (DCI) enables scheduling (multi-PDSCH/PUSCH scheduling) of multiple data channels, specifically, multiple Physical Downlink Shared Channels (PDSCH)/Physical Uplink Shared Channels (PUSCH) (Non-Patent Literature 1).

Multi-PDSCH scheduling allows collisions (allocation of duplicate radio resources) with semi-static uplink (UL) symbols (for Time Division Duplex: TDD). Multi-PUSCH scheduling also allows collisions with semi-static downlink (DL) symbols.

### CITATION LIST

### Non-Patent Literature

### [Non-Patent Literature 1]

“Final Report of 3GPP TSG PAN WG1 #104bis-e v1.0.0,” R1-2104151, 3GPP TSG PAN WG1 Meeting #105-e, 3GPP, April 2021

### SUMMARY OF INVENTION

However, if collisions between PDSCH/PUSCH and UL/DL symbols as described above are permitted, the terminal (User Equipment, UE) must continue receiving the data channel correctly even if the collision occurs.

Accordingly, the following disclosure has been made in view of this situation, and is intended to provide a terminal, a radio communication system, and a radio communication method capable of correctly continuing reception of the data channel even if collision between the PDSCH/PUSCH and the UL/DL symbol is permitted.

An aspect of the present disclosure is a terminal (UE200) including a reception unit (data transmission and reception unit 260) that receives a plurality of downlink data channels scheduled by a single downlink control information, and a control unit (control unit 270) that assumes that if any of the downlink data channels collides with the uplink symbol, the downlink data channels cancelled by the collision are excluded from the specified scheduling.

An aspect of the present disclosure is a terminal including a reception unit that receives a plurality of downlink data channels scheduled by a single downlink control information, and a control unit that determines the presence or absence of information on a code block group based on the scheduled downlink data channel or the valid downlink data channel.

An aspect of the present disclosure is a terminal including a reception unit that receives a plurality of downlink data channels scheduled by a single downlink control information, and an control unit that determines a codebook including feedback of an automatic retransmission request of the downlink data channel based on a number of the valid downlink data channels.

An aspect of the present disclosure is a terminal including a reception unit that receives a plurality of downlink data channels scheduled by a single downlink control information, and an control unit that assumes reception of the downlink data channels by semi-static scheduling cancelled by the collision when any of the downlink data channels collides with the uplink symbol.

An aspect of the present disclosure is a terminal (UE200) including a transmission unit (data transmission and reception unit 260) that transmits a plurality of uplink data channels scheduled by a single downlink control information, and a control unit (control unit 270) that assumes that if any of the uplink data channels collides with a downlink symbol, the uplink data channel canceled by the collision is excluded from the specified scheduling.

An aspect of the present disclosure is a terminal including a transmission unit that transmits a plurality of uplink data channels scheduled by a single downlink control information, and an control unit that determines reporting of channel status information based on the scheduled uplink data channel or the valid uplink data channel.

An aspect of the present disclosure is a terminal including a transmission unit that transmits a plurality of uplink data channels scheduled by a single downlink control information, and an control unit that determines presence or absence of information on a code block group based on the scheduled uplink data channel or the valid uplink data channel.

An aspect of the present disclosure is a terminal including a transmission unit that transmits a plurality of uplink data channels scheduled by a single downlink control information, and an control unit that, when any of the uplink data channels collides with a downlink symbol, stops transmission of the uplink data channel by a configured grant canceled by the collision.

### BRIEF DESCRIPTION OF DRAWINGS

FIG. 1 is an overall schematic diagram of a radio communication system 10.

FIG. 2 is a diagram showing a frequency band used in the radio communication system 10.

FIG. 3 is a diagram showing a configuration example of a radio frame, a sub-frame and a slot used in the radio communication system 10.

FIG. 4 is a functional block diagram of a gNB100 and a UE200.

FIG. 5 shows a configuration example of multi-PDSCH/PUSCH scheduling.

FIG. 6 is a diagram showing a sequence example related to scheduling of a data channel.

FIG. 7 is a diagram showing an example of a TDRA table.

FIG. 8 is a diagram showing an example of a hardware configuration of the gNB100 and the UE200.

FIG. 9 is a diagram showing a configuration example of a vehicle 2001.

### MODES FOR CARRYING OUT THE INVENTION

Exemplary embodiments of the present invention are explained below with reference to the accompanying drawings. Note that, the same or similar reference numerals have been attached to the same functions and configurations, and the description thereof is appropriately omitted.

### (1) OVERALL SCHEMATIC CONFIGURATION OF THE RADIO COMMUNICATION SYSTEM

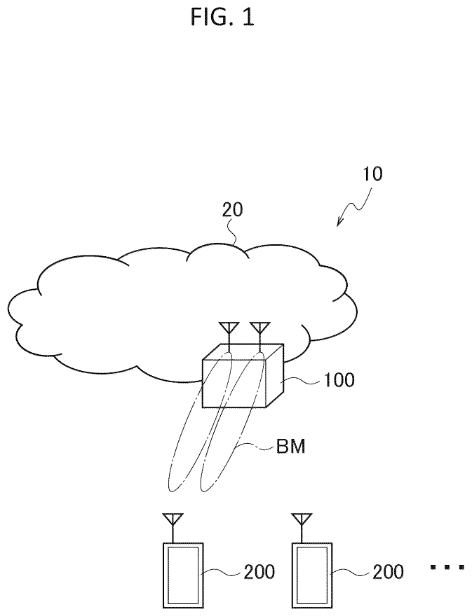

FIG. 1 is an overall schematic configuration diagram of a radio communication system 10 according to the present embodiment. The radio communication system 10 is a radio communication system according to 5G New Radio (NR) and includes a Next Generation-Radio Access Network 20 (hereinafter referred to as the NG-RAN20 and a terminal 200 (UE200, User Equipment, UE). The radio communication system 10 may be a radio communication system according to a system called Beyond 5G, 5G Evolution or 6G.

The NG-RAN20 includes a radio base station 100 (gNB100). The specific configuration of the radio communication system 10 including the number of gNBs and UEs is not limited to the example shown in FIG. 1.

The NG-RAN20 actually includes a plurality of NG-RAN Nodes, specifically gNBs (or ng-eNBs), connected to a core network (5GC, not shown) according to 5 5G. Note that the NG-RAN20 and 5 GCs may be referred to simply as “networks”.

The gNB100 is a radio base station in accordance with 5G and performs radio communication the UE200 in accordance with 5G. The gNB100 and the UE200 can support Massive MIMO (Multiple-Input Multiple-Output), which generates a more directional antenna beam (Beam BM) by controlling radio signals transmitted from multiple antenna elements; Carrier Aggregation (CA), which uses multiple component carriers (CCs) bundled together; and Dual Connectivity (DC), which simultaneously communicates between the UE and each of two NG-RAN Nodes.

The gNB100 can transmit multiple beams BM with different transmission directions (May be referred to simply as direction or radial direction or coverage, etc.) in space and time division. The gNB100 may transmit multiple beams BM simultaneously.

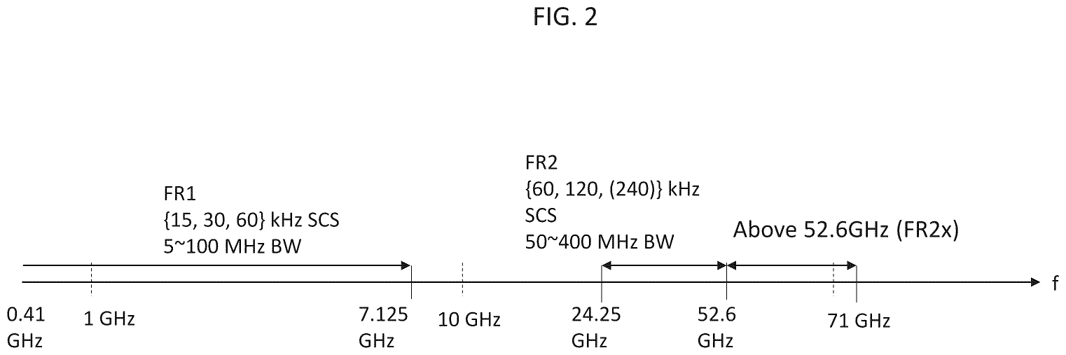

The radio communication system 10 may support multiple frequency ranges (FR). FIG. 2 shows the frequency bands used in the radio communication system 10.
FR1: 410 MHz˜7.125 GHz
FR2: 24.25 GHz˜52.6 GHz

In FR1, sub-carrier spacing (SCS) of 15, 30 or 60 kHz is used, and a bandwidth (BW) of 5˜100 MHz may be used. FR2 is higher frequency than FR1, and a sub-carrier spacing (SCS) of 60 or 120 kHz (which may include 240 kHz) is used, and a bandwidth (BW) of 50˜400 MHz may be used.

SCS may be interpreted as numerology. Numerology is defined in 3GPP TS38.300 and corresponds to one subcarrier spacing in the frequency domain.

In addition, the radio communication system 10 corresponds to a higher frequency band than the FR2 frequency band. Specifically, the radio communication system 10 corresponds to a frequency band exceeding 52.6 GHz and up to 71 GHz. Such a high frequency band may be referred to as “FR 2×” for convenience.

To solve such problems, a cyclic prefix-orthogonal frequency division multiplexing (CP-OFDM)/discrete Fourier transform-spread (DFT-S-OFDM) with greater sub-carrier spacing (SCS) may be applied when a band greater than 52.6 GHz is used.

In addition, in a high frequency band such as FR2×, an increase in phase noise between carriers is a problem, as described above. Therefore, a larger (wider) SCS or application of a single carrier waveform may be required.

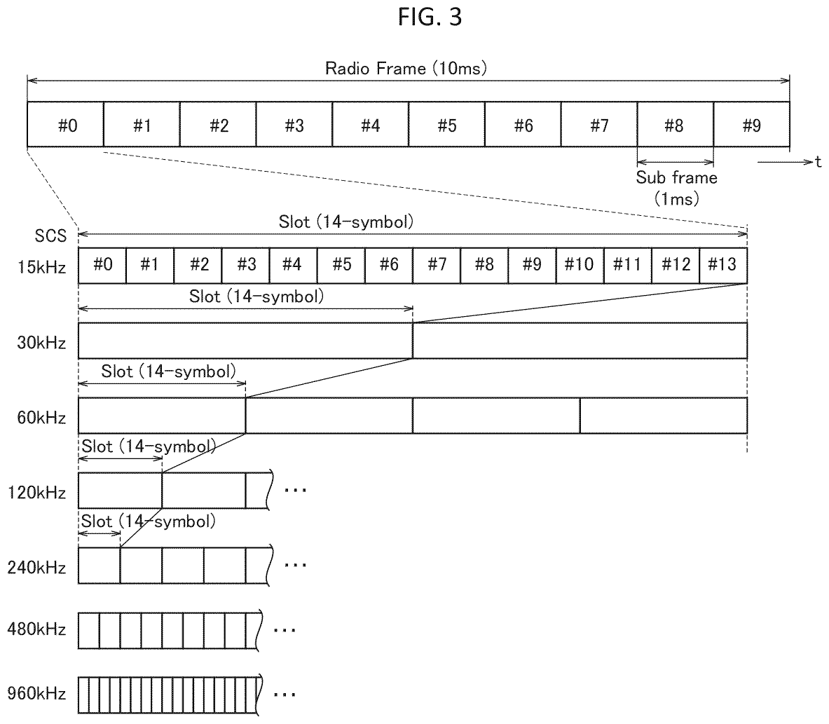

The larger the SCS, the shorter the symbol/CP (cyclic prefix) period and the slot period (if the 14 symbol/slot configuration is maintained). FIG. 3 shows an example configuration of a radio frame, sub-frame and slot used in the radio communication system 10. Table 1 shows the relationship between the SCS and the symbol period.

TABLE 1

| | 15 | 30 | 60 | 120 | 240 | 480 | 960 |
|---|---|---|---|---|---|---|---|
| SCS | kHz | kHz | kHz | kHz | kHz | kHz | kHz |
| Symbol | 66.6 | 33.3 | 16.65 | 8.325 | 4.1625 | 2.08125 | 1.040625 |
| Period | | | | | | | |
| (Unit: μs) | | | | | | | |

As shown in Table 1, when the configuration of 14 symbols/slot is maintained, the larger (wider) the SCS, the shorter the symbol period (and slot period). Note that the symbol period may be referred to as the symbol length, the time direction or the time region. The frequency direction may be referred to as the frequency region, the resource block, the subcarrier, the BWP (Bandwidth part) or the like.

The number of symbols constituting 1 slot may not necessarily be 14 symbols (For For example, 28, 56 symbols). The number of slots per subframe may vary depending on the SCS.

In the radio communication system 10, an SSB (SS/PBCH Block) composed of a synchronization signal (SS) and a physical broadcast channel (PBCH) may be used.

The SSB is transmitted from the network periodically mainly for the UE200 to perform detection of cell ID and reception timing at the start of communication. In the NR, the SSB is also used for the reception quality measurement of each cell. The transmission period (periodicity) of the SSB may be defined as 5, 10, 20, 40, 80, 160 milliseconds, etc. The UE200 of the initial access may be assumed to have a transmission period of 20 milliseconds.

The network (NG-RAN20) can notify the UE200 of the index indication (ssb-PositionsInBurst) of the SSB actually transmitted by system information (SIB1) or radio resource control layer (RRC) signaling.

The SS is composed of a primary synchronization signal (PSS) and a secondary synchronization signal (SSS).

The PSS is the known signal that the UE200 attempts to detect first in the cell search procedure. The SSS is the known signal that is transmitted to detect the physical cell ID in the cell search procedure.

The PBCH contains information necessary for the UE200 to establish frame synchronization with the NR cell formed by the gNB100 after detecting the SS/PBCH Block, such as the SFN (System Frame Number) and an index for identifying the symbol positions of multiple SS/PBCH Blocks in a half frame (5 ms).

The PBCH may also contain system parameters necessary for receiving system information (SIB). In addition, the SSB may also include a reference signal for broadcast channel demodulation (DMRS for PBCH). DMRS for PBCH is a known signal transmitted to measure the radio channel state for PBCH demodulation.

The UE200 determines, based on the received Master Information Block (MIB), that there is a CORESET for the Type0-PDCCH CSS, which may be referred to as the CORESET (CORESET 0) or the Remaining Minimum System Information (RMSI) CORESET) several contiguous resource blocks (RBs) and symbols. The UE200 configures the PDCCH (Physical Downlink Control Channel), specifically the Monitoring Opportunity (MO) of Type 0 PDCCH for System Information Block (SIB) decoding, based on the determined RBs and symbols.

CORESET 0 is a special CORESET that is different from normal CORESET. Such a particular CORESET may be interpreted as a CORESET that transmits a PDCCH for SIB1 scheduling. CORESET 0 cannot be specified by RRC because it is used before RRC signaling is transmitted.

RMSI may be interpreted to mean System Information Block 1 (SIB1). RMSI may consist of system information that a device (UE200) must know before accessing the system. SIB1 may be broadcast periodically throughout the cell at all times. SIB1 may provide the information required by the UE200 to perform the first random access (PA).

SIB1 is provided by regular scheduled Physical Downlink Shared Channel (PDSCH) transmissions with a period of 160 milliseconds. The PBCH/MIB may provide information about the numerology used for SIB1 transmissions and the search space and corresponding CORESET used for scheduling SIB1. Within the CORESET, the UE200 may monitor scheduling of SIB1 as indicated by a special System Information RNTI (SI-RNTI).

The radio communication system 10 may support Time Domain Resource Allocation (TDRA). TDRA may be interpreted as resource allocation in the Physical Uplink Shared Channel (PUSCH) time domain as specified in 3GPP TS38.214. TDRA in PUSCH may be interpreted as specified by the Information Element (IE) of the Radio Resource Control Layer (RRC), specifically PDSCH-Config or PDSCH-ConfigCommon.

TDRA may be interpreted as resource allocation in the time domain of PUSCH specified by Downlink Control Information (DCI).

Also, in the radio communication system 10, one (single) DCI may support multiple data channels, specifically, multiple Physical Downlink Shared Channel (PDSCH)/Physical Uplink Shared Channel (PUSCH) scheduling (multi-PDSCH/PUSCH scheduling).

### (2) FUNCTION BLOCK CONFIGURATION OF RADIO COMMUNICATION SYSTEM

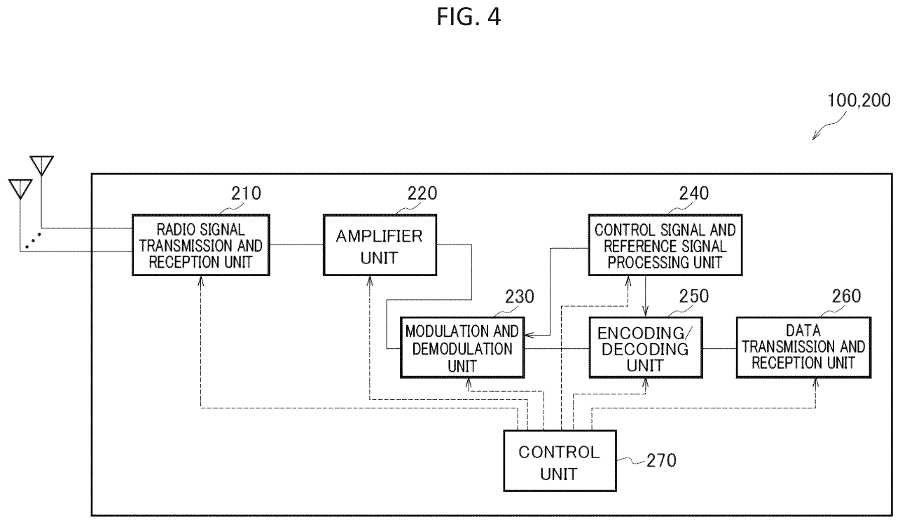

Next, the function block configuration of the radio communication system 10 will be described. Specifically, the function block configuration of the UE200 will be described. FIG. 4 is a function block configuration diagram of the gNB100 and the UE200.

As shown in FIG. 4, the UE200 includes a radio signal transmission and reception unit 210, an amplifier unit 220, a modulation and demodulation unit 230, a control signal and reference signal processing unit 240, an encoding/decoding unit 250, a data transmission and reception unit 260, and a control unit 270.

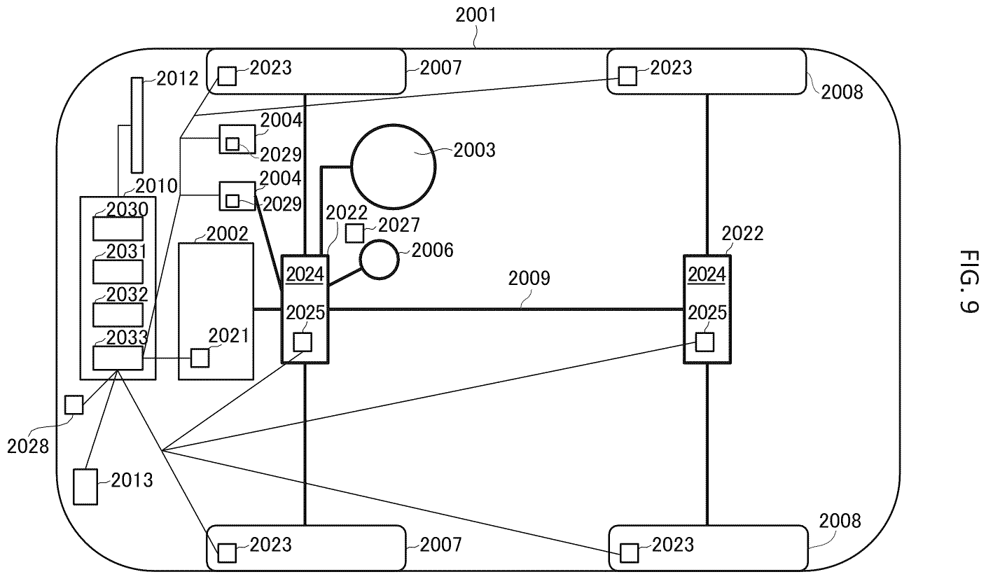

Note that in FIG. 4, only the main functional blocks related to the description of the embodiment are shown, and the UE200 (gNB100) has other functional blocks (For example, the power supply unit). FIG. 4 also shows the functional block configuration of the UE200, and the hardware configuration is described in FIG. 8.

The radio signal transmission and reception unit 210 transmits and receives radio signals in accordance with the NR. The radio signal transmission and reception unit 210 can support Massive MIMO, which generates a more directional beam by controlling radio (RF) signals transmitted from a plurality of antenna elements; Carrier Aggregation (CA), which bundles a plurality of component carriers (CCs); and Dual Connectivity (DC), which simultaneously communicates between a UE and each of two NG-RAN Nodes.

The amplifier unit 220 is composed of a PA (Power Amplifier)/LNA (Low Noise Amplifier). the amplifier unit 220 amplifies the signal output from the modulation and demodulation unit 230 to a predetermined power level. The amplifier unit 220 amplifies the RF signal output from the radio signal transmission and reception unit 210.

The modulation and demodulation unit 230 performs data modulation/demodulation, transmission power setting, resource block allocation, etc. for each predetermined communication destination (gNB100, etc.). Cyclic Prefix-Orthogonal Frequency Division Multiplexing (CP-OFDM)/Discrete Fourier Transform-Spread (DFT-S-OFDM) may be applied to the modulation and demodulation unit 230. DFT-S-OFDM may be used not only for the uplink (UL) but also for the downlink (DL).

The control signal and reference signal processing unit 240 executes processing related to various control signals transmitted and received by the UE200 and various reference signals transmitted and received by the UE200.

Specifically, the control signal and reference signal processing unit 240 receives various control signals transmitted from the gNB100 via a predetermined control channel, for example, a radio resource control layer (RRC) control signal. The control signal and reference signal processing unit 240 also transmits various control signals to the gNB100 via a predetermined control channel.

The control signal and reference signal processing unit 240 executes processing using a reference signal (RS) such as a demodulation reference signal (DMRS) and a phase tracking reference signal (PTRS).

The DMRS is a known reference signal (pilot signal) between a base station and a terminal of each terminal for estimating a fading channel used for data demodulation. The PTRS is a reference signal of each terminal for estimating phase noise, which is a problem in a high frequency band.

In addition to the DMRS and PTRS, the reference signal may include a Channel State Information-Reference Signal (CSI-RS), a Sounding Reference Signal (SRS), and a Positioning Reference Signal (PRS) for position information.

The channel may include a control channel and a data channel. The control channel may include a Physical Downlink Control Channel (PDCCH), a Physical Uplink Control Channel (PUCCH), a RACH(Random Access Channel, Downlink Control Information (DCI) with Random Access Radio Network Temporary Identifier (RA-RNTI)), and a Physical Broadcast Channel (PBCH).

The data channel may also include a Physical Downlink Shared Channel (PDSCH), a Physical Uplink Shared Channel (PUSCH), and the like. Data may mean data transmitted over the data channel.

The control signal and reference signal processing unit 240 may also transmit the capability information of the UE200 for scheduling the data channel to the network.

Specifically, the control signal and reference signal processing unit 240 can transmit UE Capability Information regarding scheduling of PDSCH and PUSCH to gNB100. Further details of UE Capability Information will be described later.

The encoding/decoding unit 250 performs data partitioning/concatenation and channel coding/decoding for each predetermined communication destination (gNB100 or other gNB).

Specifically, the encoding/decoding unit 250 divides the data output from the data transmission and reception unit 260 into predetermined sizes and performs channel coding for the divided data. the encoding/decoding unit 250 decodes the data output from the modulation and demodulation unit 230 and concatenates the decoded data.

The data transmission and reception unit 260 transmits and receives protocol data units (PDU) and service data units (SDU). Specifically, the data transmission and reception unit 260 performs assembly/disassembly of PDUs/SDUs in a plurality of layers (Media access control layer (MAC), radio link control layer (RLC), packet data convergence protocol layer (PDCP), etc.). The data transmission and reception unit 260 executes error correction and retransmission control of data based on a hybrid automatic repeat request (ARQ).

The data transmission and reception unit 260 can receive a plurality of downlink data channels (PDSCH) scheduled by one (single) downlink control information (DCI). The data transmission and reception unit 260 can transmit a plurality of uplink data channels (uplink data channels) scheduled by a single downlink control information (DCI). In this embodiment, the data transmission and reception unit 260 may comprise a reception unit for the downlink data channel and a transmission unit for transmitting the uplink data channel.

The control unit 270 controls each function block that constitutes the UE200. In particular, in this embodiment, the control unit 270 can perform control related to multi-PDSCH/PUSCH scheduling.

First, control related to multi-PDSCH scheduling will be described. the control unit 270 may assume that if any PDSCH out of a plurality of PDSCH by multi-PDSCH scheduling collides with a UL symbol, the PDSCH cancelled by the collision is excluded from the specific scheduling.

Here, the UL symbol may be interpreted as a symbol assigned semi-static in a slot. Multi-PDSCH scheduling may allow conflicts with such semi-static UL symbols, specifically overlapping resources in the time direction. In other words, multi-PDSCH scheduling may cause conflicts between PDSCH and semi-static UL symbols in Time Division Duplex (TDD).

Specific scheduling may mean out-of-order scheduling (OoO scheduling). In OoO scheduling, the UE200 may operate as follows:
For any two HARQ process IDs in a given scheduled cell, if the UE200 is scheduled to begin receiving the first PDSCH beginning with symbol j and ending with symbol i, the UE200 does not expect to be scheduled to receive the PDSCH beginning before the end of the first PDSCH with a PDCCH ending later than symbol i.
For any two HARQ process IDs in a given scheduled cell, if UE200 is scheduled to start the first PUSCH transmission by a PDCCH that starts with symbol j and ends with symbol i, UE200 does not expect to be scheduled to transmit a PUSCH that starts before the end of the first PUSCH by a PDCCH that ends later than symbol i.

The control unit 270 may determine, in multi-PDSCH scheduling, the presence or absence of information about a code block group (CBG) based on a scheduled or valid PDSCH.

Specifically, in the case of a DL grant DCI set based on a TDRA table containing a plurality of SLIVs (Start and Length Indicator Values), the control unit 270 may determine the presence or absence (presence) of CBGTI (transmission information) and/or CBGFI (flushing out information) fields of the DCI based on a scheduled or valid PDSCH.

The valid PDSCH may be interpreted as a PDSCH that does not collide with a semi-static UL symbol.

The control unit 270 may also determine, based on the number of valid PDSCH, a codebook to include feedback on the hybrid automatic repeat request (HARQ) of the PDSCH.

Specifically, the control unit 270 may include HARQ-ACK in any subcodebook (first sub-codebook or second sub-codebook) based on the number of valid PDSCH in type 2 HARQ-ACK (Acknowledgement) feedback for DL grant DCIs configured based on a TDRA table containing multiple SLIV (Start and Length Indicator Value).

Alternatively, the control unit 270 may include HARQ-ACK in the second sub-codebook regardless of the number of valid or invalid PDSCH.

The first sub-codebook may mean a sub-codebook for DCI that schedules only one PDSCH (That is, it indicates that the TDRA table contains only one SLIV). The types 1 and 2 are based on differences in codebook decision algorithms, and the HARQ-ACK codebook may be set dynamically in type 2.

The control unit 270 may assume that when any PDSCH by multi-PDSCH scheduling collides with a UL symbol, the PDSCH is received by semi-static scheduling cancelled by the collision.

Specifically, the control unit 270 may assume receipt of a Semi-Persistent Scheduling (SPS) PDSCH that overlaps the PDSCH cancelled by the collision (That is, using the same radio resources).

Next, control related to multi-PUSCH scheduling will be described. the control unit 270 may assume that if any of the PUSCHs in the multi-PUSCH scheduling collides with a DL symbol, the PUSCH cancelled by the collision is excluded from OoO scheduling.

Here, the DL symbol may be interpreted as a semi-static symbol assigned in a slot. Multi-PUSCH scheduling may allow collisions with such semi-static DL symbols, SSB symbols and/or CORESET 0 symbols, specifically overlapping resources in the time direction. That is, multi-PUSCH scheduling may cause collisions between multi-PUSCH scheduling and semi-static UL symbols in Time Division Duplex (TDD).

The control unit 270 may decide to report Channel State Information (CSI) in multi-PUSCH scheduling based on scheduled PUSCH or valid PUSCH. Specifically, the control unit 270 may cause a CSI report to be based on a scheduled or enabled PUSCH in the case of an A-CSI (Aperiodic-CSI) report triggered by a UL grant DCI configured based on a TDRA table containing multiple SLIVs (Start and Length Indicator Values).

The enabled PUSCH may be interpreted as a PUSCH that does not collide with a semi-static UL symbol, a symbol set to SSB and/or CORESET 0.

In multi-PUSCH scheduling, the control unit 270 may determine the presence or absence of code block group (CBG) information based on the scheduled PUSCH or the enabled PUSCH.

Specifically, in the case of a UL grant DCI set based on a TDRA table containing multiple SLIVs, the control unit 270 may determine the presence or absence (presence) of CBGTI and/or CBGFI fields of the DCI based on the scheduled PUSCH or the enabled PUSCH.

The control unit 270 may allow the transmission of a Configured Grant (CG) PUSCH that overlaps with a canceled PUSCH. the control unit 270 may also allow the transmission of a CG PUSCH that has the same HARQ process ID as the canceled PUSCH.

Here, in multi-PUSCH scheduling, if any PUSCH collides with a DL symbol, the control unit 270 may stop transmitting the PUSCH by the CG cancelled by the collision.

Specifically, the control unit 270 indicates that the operations described in 3GPP TS 38.213, Chapters 11 and 11.1 (Release 15, 16) for PUSCHs that do not use DCI may also be applied to CG PUSCHs. That is, if a CG PUSCH overlaps a DL symbol, the CG PUSCH need not be transmitted.

Alternatively, the control unit 270 may not transmit a CG PUSCH that overlaps a cancelled PUSCH and/or has the same HARQ process ID.

The gNB100 (data transmission and reception unit 260) may also comprise a transmission unit that transmits multiple downlink data channels (PDSCH) scheduled by a single downlink control information (DCI) and a reception unit that receives multiple uplink data channels (PUSCH) according to multi-PDSCH/PUSCH scheduling.

### (3) OPERATION OF RADIO COMMUNICATION SYSTEM

Next, the operation of the radio communication system 10 will be described. Specifically, the operation related to multi-PDSCH/PUSCH scheduling, especially when PDSCH/PUSCH collides (allocates duplicate radio resources) with semi-static UL/DL symbols and the like in TDD will be described.

### (3.1) Assumptions

3GPP Release-17 may support multi-PDSCH/PUSCH scheduling, allowing the following collisions:
For multi-PDSCH scheduling, collisions with semi-static UL symbols
For multi-PUSCH scheduling, collisions with semi-static DL, SSB, and CORESET 0 symbols

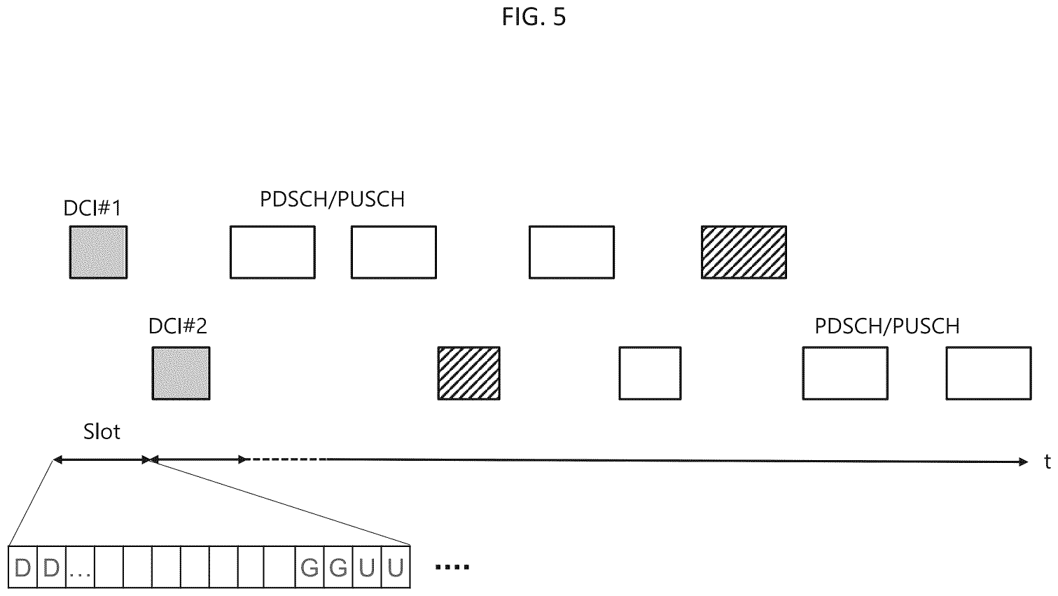

FIG. 5 shows an example configuration of multi-PDSCH/PUSCH scheduling. As shown in FIG. 5, multi-PDSCH/PUSCH scheduling allows multiple PDSCH/PUSCHs to be scheduled by one (single) DCI. On the other hand, the slot format includes a semi-static symbol (UL or DL symbols, may also include guard (G) symbols).

Thus, in the TDD, PDSCH/PUSCH may collide with the symbol. Scheduling of PDSCH/PUSCH (see hatched border in the figure), where such a collision may occur, is also permitted, but in practice the data channel cannot be transmitted.

In view of this situation, it is considered that there are the following problems.
(Issue 1): It is not clear whether PDSCH/PUSCH cancelled due to collision with semi-static UL/DL symbols will be considered in OoO scheduling.
(Issue 2): For A-CSI reports triggered by DCIs scheduling multiple PUSCHs with multi-PUSCH scheduling, it is assumed that the provisions of 3GPP Release-16 apply, but the rules do not take into account the cancellation of PUSCHs due to collisions with DL symbols.
(Issue 3): When the number of PUSCHs is used to determine the presence of a CBGTI field, it is not clear whether it should be based on the number of scheduled PUSCHs or the number of valid PUSCHs. Also, when the number of PDSCHs is used to determine the presence of a CBGTI/CBGFI field, it is not clear whether it should be based on the number of scheduled PDSCHs or the number of valid PDSCHs.
(Issue 4): PDSCH cancellations due to collisions with semi-static UL symbols are not considered. For example, if the DCI schedules multiple PDSCH and only one PDSCH is valid, it is not clear whether the HARQ-ACK feedback should be included in the first sub-codebook or the second sub-codebook.
(Issue 5): In multi-PDSCH scheduling, of multiple PDSCH scheduled by a single DCI, one PDSCH is cancelled because of a collision with a semi-static UL symbol, but if it meets the timeline, it is not clear whether the SPS PDSCH can be received and whether it is acceptable to schedule another PDSCH that overlaps with the cancelled PDSCH.
(Issue 6): In multi-PUSCH scheduling, among multiple PUSCHs scheduled by a single DCI, one PUSCH is cancelled due to a collision with a semi-static UL symbol, but it is not clear whether CG PUSCH overlapping with the cancelled PUSCH can be transmitted when the timeline is satisfied, and whether CG PUSCH overlapping with the same HARQ processing as the cancelled PUSCH can be transmitted when the timeline is satisfied. Also, it is not clear whether another PUSCH overlapping with the cancelled PUSCH can be scheduled.

### (3.2) Example of Operation

Next, an operation example 1˜6 corresponding to the above-mentioned problem 1˜6 will be described. First, a sequence example related to scheduling of data channels (PDSCH/PUSCH) will be described.

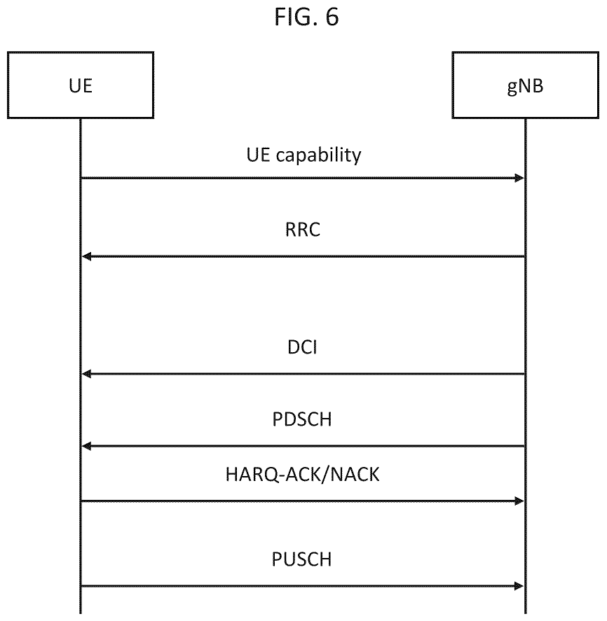

FIG. 6 shows a sequence example related to scheduling of data channels. As shown in FIG. 6, UE200 may transmit UE Capability Information to the network, specifically to gNB100. In particular, an example of UE Capability Information pertaining to this operation example will be described later.

The gNB100 can perform configuration by RRC based on the capability of the UE200. The gNB100 may also transmit DCI to the UE200. As noted above, in multi-PDSCH/PUSCH scheduling, a single DCI may schedule multiple PDSCH/PUSCHs.

The gNB100 may transmit multiple PDSCH to the UE200 in response to scheduling by the DCI. The UE200 may transmit HARQ feedback (ACK or NACK) for receipt of the PDSCH to the gNB100. As noted above, types 1 and 2 may be supported for HARQ-ACK feedback.

The UE200 may also transmit multiple PUSCHs to the gNB100 in accordance with the multi-PUSCH scheduling.

### (3.2.1) Example 1

This example corresponds to Problem 1 and relates to OoO scheduling. If a PDSCH by multi-PDSCH scheduling is cancelled due to a collision with a UL symbol in semi-static, any of the following actions may be applied to a PDSCH included in a plurality of PDSCH scheduled by multi-PDSCH scheduling.
(Option 1-1): The cancelled PDSCH is not considered in the OoO scheduling decision.

The behavior of UE200 may be acceptable if the cancelled PDSCH is scheduled by the previous DCI and ends later than the start of the PDSCH scheduled by the later DCI.

Using the specification representation of 3GPP, if for any two HARQ process IDs in a given schedule cell, the UE is scheduled to start receiving the first PDSCH by a PDCCH starting with symbol j and ending with symbol i, if the first PDSCH does not overlap with any semi-static UL symbol, then the UE does not expect to be scheduled to receive the second PDSCH starting earlier than the end of the first PDSCH with symbol I, a PDCCH ending later than if the second PDSCH does not overlap with any semi-static UL symbol (For any two HARQ process IDs in a given scheduled cell, if the UE is scheduled to start receiving a first PDSCH starting in symbol j by a PDCCH ending in symbol i, where the first PDSCH does not overlap with any semi-static UL symbol, the UE is not expected to be scheduled to receive a second PDSCH starting earlier than the end of the first PDSCH with a PDCCH that ends later than symbol I, where the second PDSCH does not overlap with any semi-static UL symbol.).
(Option 1-2): Cancelled PDSCH will continue to be considered in OoO scheduling decisions.

The behavior of UE200 is that the start of PDSCH scheduled by the later DCI should be later than the end of PDSCH scheduled by the earlier DCI.

Also, if PUSCH by multi-PUSCH scheduling is cancelled due to collision with semi-static DL symbols, SSB symbols and/or CORESET 0 symbols, one of the following behaviors may apply for PUSCH included in multiple PUSCHs scheduled by multi-PUSCH scheduling:
(Option 2-1): The cancelled PUSCH is not considered in the OoO scheduling decision.

The behavior of UE200 may be acceptable if it is scheduled by the previous DCI and the cancelled PUSCH ends later than the start of the PUSCH scheduled by the later DCI.

Using the 3GPP specification representation, if for any two HARQ process IDs in a given schedule cell, the UE is scheduled to begin receiving the first PUSCH with a PDCCH that begins with symbol j and ends with symbol i, then if the first PUSCH does not overlap with any semi-static UL symbol, SSB symbol and CORESET 0 symbol, then the UE does not expect to be scheduled to receive the second PUSCH that begins earlier than the end of the first PUSCH with a PDCCH that ends later than if symbol I, the second PUSCH does not overlap with any semi-static UL symbol, SSB symbol and CORESET 0 symbol (For any two HARQ process IDs in a given scheduled cell, if the UE is scheduled to start a first PUSCH transmission starting in symbol j by a PDCCH ending in symbol i, where the first PUSCH does not overlap with any with semi-static DL symbol, and/or symbol configured for SSB or CORESET #0, the UE is not expected to be scheduled to transmit a second PUSCH starting earlier than the end of the first PUSCH by a PDCCH that ends later than symbol I, where the second PUSCH does not overlap with any with semi-static DL symbol, and/or symbol configured for SSB or CORESET #0.).
(Option 2-2): Cancelled PUSCHs will continue to be considered in OoO scheduling decisions.

The behavior of UE200 is that the start of any PUSCH scheduled by a later DCI should be later than the end of any PUSCH scheduled by a previous DCI.

### (3.2.2) Example 2

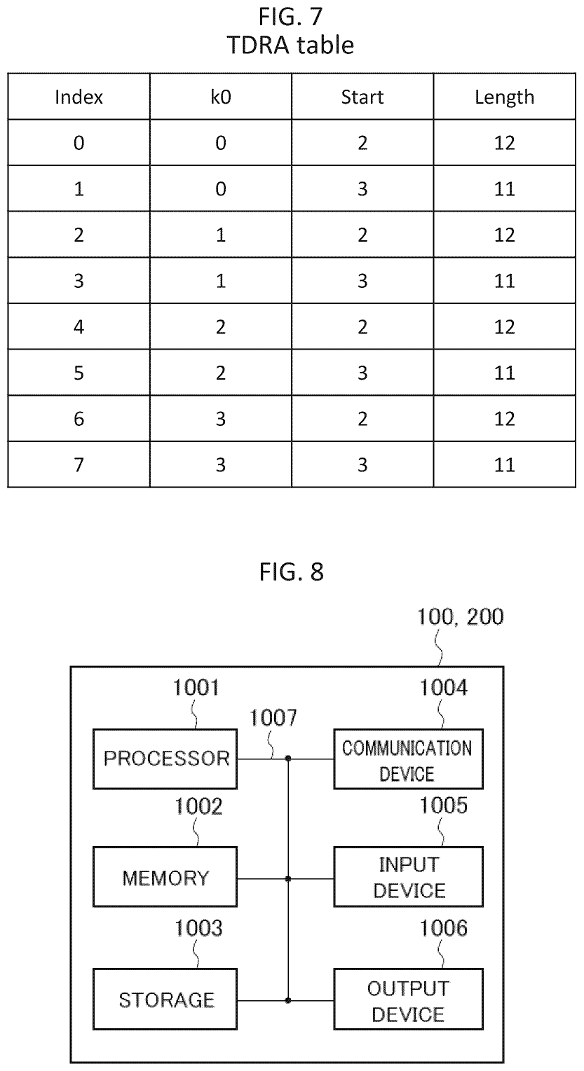

This example corresponds to Problem 2 and relates to A-CSI reporting. FIG. 7 shows an example of a TDRA table.

For an A-CSI report triggered by an ULgrant DCI configured according to a TDRA table containing multiple SLIVs in at least one row, such as the TDRA table of FIG. 7, any of the following actions may be applied:
(Option 1): The A-CSI report is determined based on the scheduled PUSCH.

The behavior of UE200 is to assume that the number of scheduled PUSCHs is M, and if M≤UE200 may report the A-CSI report at the M-th scheduled PUSCH.

If M>2, UE200 may report the A-CSI report at the (M-1)-th scheduled PUSCH.

Note that the PUSCH used for the A-CSI report may be cancelled due to collisions with semi-static DL symbols, SSB symbols and/or symbols set to CORESET 0.

Also, if the PUSCH determined for the A-CSI report is cancelled due to a collision with the DL symbol SSB symbol and/or the symbol set to CORESET0, one of the following actions may be applied:
(Alt 1): The last valid PUSCH before the determined PUSCH is used for the A-CSI report.
(Alt 2): The last scheduled PUSCH is used for the A-CSI report.
(Alt 3): The A-CSI report is not done.
(Option 2): The A-CSI report is determined based on the valid PUSCH.

The behavior of UE200 is to assume that the number of scheduled PUSCHs is M and the number of valid PUSCHs is N, and if N≤UE200 may report an A-CSI report at the Nth valid PUSCH.

If N>2, UE200 may report an A-CSI report at the (N−1) th valid PUSCH.

As described above, a valid PUSCH may be interpreted as a PUSCH that does not conflict with semi-static UL symbols, SSBs and/or symbols set to CORESET 0.

In the case of this option, the PUSCH used for A-CSI report may be canceled due to a conflict with DL symbols, SSBs or symbols set to CORESET 0.

### (3.2.3) Example 3

This operation example corresponds to the problem 3 and relates to CBG-based transmission. For a DLgrant DCI set according to a TDRA table including a plurality of SLIVs in at least one row, as in the TDRA table of FIG. 7, any of the following operations may be applied.
(Option 1-1): The presence of the CBGTI/CBGFI field is determined based on the scheduled PDSCH.

If the number of scheduled PDSCH by DCI is 1, the presence of the CBGTI/CBGFI field may be assumed. If the number of scheduled PDSCH by DCI is greater than 1, the absence of the CBGTI/CBGFI field may be assumed.
(Option 1-2): The presence of the CBGTI/CBGFI field is determined based on the valid PDSCH.

If the number of PDSCH scheduled by DCI is one, then the CBGTI/CBGFI field may be assumed to exist. If the number of PDSCH scheduled by DCI is greater than one, then:
If the number of valid PDSCH is one, then the CBGTI/CBGFI field may be assumed to exist.
If the number of valid PDSCH is greater than one, then the CBGTI/CBGFI field may be assumed not to exist.

Also, for ULgrant DCIs configured according to a TDRA table that contains more than one SLIV in at least one row, any of the following actions may be applied:
(Option 2-1): The presence of the CBGTI field is determined based on the scheduled PUSCH.

If the number of scheduled PUSCHs by DCI is one, the CBGTI field may be assumed to exist. If the number of scheduled PUSCHs by DCI is greater than one, the CBGTI field may be assumed not to exist.
(Option 2-2): The existence of the CBGTI field is determined based on the valid PUSCHs. If the number of scheduled PUSCHs by the DCI is 1, the CBGTI field may be assumed to exist. If the number of scheduled PUSCHs by the DCI is greater than 1, the following operation may occur:
   If the number of valid PUSCHs is one, the CBGTI field may be assumed to exist.
   If the number of valid PUSCHs is greater than 1, the CBGTI field may be assumed to be absent.

### (3.2.4) Example 4

This example corresponds to Problem 4 and relates to type-2 HARQ-ACK feedback. For DL grant DCIs that are configured according to a TDRA table containing multiple SLIVs in at least one row and that schedule multiple PDSCH, such as the TDRA table in FIG. 7, any of the following actions may be applied:
(Option 1): The HARQ-ACK information is included in the second sub-codebook regardless of the number of invalid/valid PDSCH.
(Option 2): The HARQ-ACK information may be included in the first or second sub-codebook based on the number of valid PDSCH.

In this case, if there is only one valid PDSCH among the multiple scheduled PDSCH, the HARQ-ACK information of the DCI may be included in the first subcodebook. If there are multiple valid PDSCH among the multiple scheduled PDSCH, the HARQ-ACK information of the DCI may be included in the second subcodebook.

Note that the first subcodebook may mean a subcodebook for the DCI that schedules only one PDSCH (that is, the TDRA row contains only one SLIV).

### (3.2.5) Example 5

This example corresponds to Problem 5 and relates to handling of SPS/DG PDSCH in the event of collision. A PDSCH included in a plurality of PDSCH scheduled by a single DCI, where the PDSCH is cancelled due to collision with a semi-static UL symbol. In this case, if the timeline specified in 3GPP Release-16 is met, it may be overwritten by SPS (PDSCH rescheduling). Specifically, any of the following actions may be applied:
(Option 1-1): It may be assumed that the SPS PDSCH overlapping the cancelled PDSCH can be received.

The operation described in 3GPP TS 38.213, Chapters 11 and 11.1 (Release 15, 16) for PDSCH without DCI may also apply to SPS PDSCH. That is, if the SPS PDSCH overlaps with a UL symbol, the SPS PDSCH need not be received.
(Option 1-2): It may be assumed that the SPS PDSCH that overlaps with the canceled PDSCH will not be received.

In addition, any of the following actions may be applied to the resources of the canceled PDSCH:
(Option 2-1): The DCI can schedule another dynamic PDSCH for the remaining valid symbols of the cancelled PDSCH.
(Option 2-2): Do not expect the DCI to schedule another dynamic PDSCH for the remaining valid symbols of the cancelled PDSCH.

### (3.2.6) Example 6

This example corresponds to Problem 6, and relates to handling of CG/DG PUSCH during collision. A PUSCH included in a plurality of PUSCHs scheduled by a single DCI, in which the PUSCH is canceled due to collision with semi-static DL symbols, SSB symbols and/or symbols set to CORESET 0. In this case, if the timeline specified in 3GPP Release-16 is satisfied, it may be overwritten by the CG (PUSCH rescheduling). Specifically, any of the following actions may be applied:
(Option 1-1): It may be assumed that a CG PUSCH that overlaps a cancelled PUSCH can be sent.

The behavior described in 3GPP TS 38.213, Chapters 11 and 11.1 (Release 15, 16) for PUSCHs that do not use DCI may also apply to CG PUSCHs. That is, if a CG PUSCH overlaps a DL symbol, the CG PUSCH need not be transmitted.
(Option 1-2): It may be assumed that a CG PUSCH that overlaps a cancelled PUSCH is not transmitted.

Also, if the timeline specified in 3GPP Release-16 is met, any of the following actions may be applied for DG/CG HARQ process collisions:
(Option 2-1): It may be assumed that a CG PUSCH with the same HARQ process ID as the canceled PUSCH can be transmitted.

The actions described in 3GPP TS 38.213, Chapters 11 and 11.1 (Release 15, 16) for PUSCH without DCI may also apply to CG PUSCH. That is, if CG PUSCH overlaps a DL symbol, CG PUSCH need not be transmitted.
(Option 2-2): CG PUSCH with the same HARQ process ID as the canceled PUSCH need not be transmitted.

In addition, any of the following actions may be applied to the resources of the canceled PUSCH:
(Option 3-1): The DCI may schedule another dynamic PUSCH for the remaining valid symbols of the canceled PUSCH.
(Option 3-2): Do not expect DCI to schedule another dynamic PUSCH for the remaining valid symbols of the canceled PUSCH.

### (3.2.7) Modifications

With respect to the above operation example, the following modifications may be further applied. Specifically, a decision as to which operation example (option) is to be applied may be based on either of the following:
Higher layer (e.g., RRC) parameters
UE capability reporting from UE200
3GPP Specifications
Configuring higher layer parameters in Combination with reported UE Capability

The operation example may be limited to the following conditions.
52.6˜71 GHz(FR2×)
Unlicensed frequency band
Specific SCS
Any combination of the above

### (3.2.8) UE Capability

The UE capability of the UE200 for multi-PDSCH/PUSCH scheduling may include at least one of the following:
OoO scheduling support considering cancelled PDSCH
OoO scheduling support considering cancelled PUSCH
A-CSI report support considering cancelled PUSCH
CBG-based scheduling support considering cancelled PDSCH
CBG-based scheduling support considering cancelled PUSCH
Type 2 HARQ-ACK CB generation support considering cancelled PDSCH
SPS PDSCH override support considering cancelled PDSCH
Support for allocating resources of cancelled PDSCH to another dynamic grant PDSCH
Support for overwriting CG PDSCH considering cancelled PUSCH
Support for allocating resources of cancelled PUSCH to another dynamic grant PUSCH

### (4) OPERATIONAL EFFECTS

According to the above-described embodiment, the following effects can be obtained. Specifically, according to the above-mentioned gNB100 and UE200, even when multi-PDSCH/PUSCH scheduling is applied and collision between PDSCH/PUSCH and UL/DL symbols is permitted, operation according to the operation example 1˜6 can be executed, and thus reception of PDSCH/PUSCH can be continued normally.

That is, according to the gNB100 and UE200, appropriate multi-PDSCH/PUSCH scheduling considering collision at TDD can be realized.

### (5) OTHER EMBODIMENTS

Although the embodiments have been described above, they are not limited to the description of the embodiments, and it is obvious to those skilled in the art that various modifications and improvements can be made.

For example, in the above-described embodiment, PDSCH/PUSCH has been described as an example, but the same operation may be applied to a plurality of data channels scheduled by a single DCI.

In the foregoing description, setting (configure), activating (activate), updating (update), indicating (indicate), enabling (enable), specifying (specify), and selecting (select) may be interchanged. Similarly, link, associate, correspond, and map may be interchanged, and allocate, assign, monitor, and map may be interchanged.

In addition, specific, dedicated, UE-specific, and UE-specific may be interchanged. Similarly, common, shared, group-common, UE-common, and UE-shared may be interchanged.

Further, the block configuration diagram (FIG. 4) used in the description of the above embodiment shows blocks of functional units. Those functional blocks (structural components) can be realized by a desired combination of at least one of hardware and software. Means for realizing each functional block is not particularly limited. That is, each functional block may be realized by one device combined physically or logically. Alternatively, two or more devices separated physically or logically may be directly or indirectly connected (for example, wired, or wireless) to each other, and each functional block may be realized by these plural devices. The functional blocks may be realized by combining software with the one device or the plural devices mentioned above.

Functions include judging, deciding, determining, calculating, computing, processing, deriving, investigating, searching, confirming, receiving, transmitting, outputting, accessing, resolving, selecting, choosing, establishing, comparing, assuming, expecting, considering, broadcasting, notifying, communicating, forwarding, configuring, reconfiguring, allocating (mapping), assigning, and the like. However, the functions are not limited thereto. For example, the functional block (component) that functions transmission is called a transmission unit (transmitting unit) or a transmitter. As described above, the method of realization of both is not particularly limited.

In addition, the above-mentioned gNB100 and UE200 (the device) may function as a computer for processing the radio communication method of the present disclosure. FIG. 8 is a diagram showing an example of the hardware configuration of the device. As shown in FIG. 8, the device may be configured as a computer device including a processor 1001, a memory 1002, a storage 1003, a communication device 1004, an input device 1005, an output device 1006 and a bus 1007.

Furthermore, in the following explanation, the term “device” can be replaced with a circuit, device, unit, and the like. Hardware configuration of the device can be constituted by including one or plurality of the devices shown in the figure, or can be constituted by without including a part of the devices.

Each functional block of the device (see FIG. 4) is implemented by any hardware element of the computer device or a combination of the hardware elements.

Moreover, the processor 1001 performs computing by loading a predetermined software (computer program) on hardware such as the processor 1001 and the memory 1002, and realizes various functions of the reference device by controlling communication via the communication device 1004, and controlling reading and/or writing of data on the memory 1002 and the storage 1003.

Processor 1001, for example, operates an operating system to control the entire computer. Processor 1001 may be configured with a central processing unit (CPU) including an interface to peripheral devices, a controller, a computing device, a register, etc.

Moreover, the processor 1001 reads a computer program (program code), a software module, data, and the like from the storage 1003 and/or the communication device 1004 into the memory 1002, and executes various processes according to the data. As the computer program, a computer program that is capable of executing on the computer at least a part of the operation explained in the above embodiments is used. Alternatively, various processes explained above can be executed by one processor 1001 or can be executed simultaneously or sequentially by two or more processors 1001. The processor 1001 can be implemented by using one or more chips. Alternatively, the computer program can be transmitted from a network via a telecommunication line.

The memory 1002 is a computer readable recording medium and is configured, for example, with at least one of Read Only Memory (ROM), Erasable Programmable ROM (EPROM), Electrically Erasable Programmable ROM (EEPROM), Random Access Memory (RAM), and the like. Memory 1002 may be referred to as a register, cache, main memory (main storage), etc. The memory 1002 can store programs (program codes), software modules, and the like that can execute the method according to one embodiment of the present disclosure.

The storage 1003 is a computer readable recording medium. Examples of the storage 1003 include an optical disk such as Compact Disc ROM (CD-ROM), a hard disk drive, a flexible disk, a magneto-optical disk (for example, a compact disk, a digital versatile disk, Blu-ray (Registered Trademark) disk), a smart card, a flash memory (for example, a card, a stick, a key drive), a floppy (Registered Trademark) disk, a magnetic strip, and the like. The storage 1003 can be called an auxiliary storage device. The recording medium can be, for example, a database including the memory 1002 and/or the storage 1003, a server, or other appropriate medium.

The communication device 1004 is hardware (transmission/reception device) capable of performing communication between computers via a wired and/or wireless network. The communication device 1004 is also called, for example, a network device, a network controller, a network card, a communication module, and the like.

The communication device 1004 includes a high-frequency switch, a duplexer, a filter, a frequency synthesizer, and the like in order to realize, for example, at least one of Frequency Division Duplex (FDD) and Time Division Duplex (TDD).

The input device 1005 is an input device (for example, a keyboard, a mouse, a microphone, a switch, a button, a sensor, and the like) that accepts input from the outside. The output device 1006 is an output device (for example, a display, a speaker, an LED lamp, and the like) that outputs data to the outside. Note that, the input device 1005 and the output device 1006 may be integrated (for example, a touch screen).

Each device, such as the processor 1001 and the memory 1002, is connected by a bus 1007 for communicating information. The bus 1007 may be configured using a single bus or a different bus for each device.

In addition, the device may be configured to include hardware such as a microprocessor, a digital signal processor (DSP), an application specific integrated circuit (ASIC), a programmable logic device (PLD), a field programmable gate array (FPGA), or the like, which may provide some or all of each functional block. For example, the processor 1001 may be implemented by using at least one of these hardware.

The notification of information is not limited to the aspects/embodiments described in the present disclosure and may be carried out using other methods. For example, the notification of information may be performed by physical layer signaling (e.g., Downlink Control Information (DCI), Uplink Control Information (UCI), higher layer signaling (e.g., RRC signaling, Medium Access Control (MAC) signaling, Notification Information (Master Information Block (MIB), System Information Block (SIB)), other signals or combinations thereof. RRC signaling may also be referred to as RRC messages, e.g., RRC Connection Setup messages, RRC Connection Reconfiguration messages, etc.

Each of the above aspects/embodiments can be applied to at least one of Long Term Evolution (LTE), LTE-Advanced (LTE-A), SUPER 3G, IMT-Advanced, 4th generation mobile communication system (4G), 5th generation mobile communication system (5G), Future Radio Access (FRA), New Radio (NR), W-CDMA (Registered Trademark), GSM (Registered Trademark), CDMA2000, Ultra Mobile Broadband (UMB), IEEE 802.11 (Wi-Fi (Registered Trademark)), IEEE 802.16 (WiMAX (Registered Trademark)), IEEE 802.20, Ultra-WideBand (UWB), Bluetooth (Registered Trademark), a system using any other appropriate system, and a next-generation system that is expanded based on these. Further, a plurality of systems may be combined (for example, a combination of at least one of the LTE and the LTE-A with the 5G).

The processing steps, sequences, flowcharts, etc., of each of the embodiments/embodiments described in the present disclosure may be reordered as long as there is no conflict. For example, the method described in the present disclosure presents the elements of the various steps using an exemplary sequence and is not limited to the particular sequence presented.

The specific operation that is performed by the base station in the present disclosure may be performed by its upper node in some cases. In a network constituted by one or more network nodes having a base station, the various operations performed for communication with the terminal may be performed by at least one of the base station and other network nodes other than the base station (for example, MME, S-GW, and the like may be considered, but not limited thereto). In the above, an example in which there is one network node other than the base station is explained; however, a combination of a plurality of other network nodes (for example, MME and S-GW) may be used.

Information, signals (information and the like) can be output from a higher layer (or lower layer) to a lower layer (or higher layer). It may be input and output via a plurality of network nodes.

The input/output information can be stored in a specific location (for example, a memory) or can be managed in a management table. The information to be input/output can be overwritten, updated, or added. The information can be deleted after outputting. The inputted information can be transmitted to another device.

The determination may be made by a value (0 or 1) represented by one bit or by Boolean value (Boolean: true or false), or by comparison of numerical values (for example, comparison with a predetermined value).

Each of the embodiments/embodiments described in the present disclosure may be used alone, in combination, or alternatively with execution. In addition, notification of predetermined information (for example, notification of “being X”) is not limited to being performed explicitly, it may be performed implicitly (for example, without notifying the predetermined information).

Instead of being referred to as software, firmware, middleware, microcode, hardware description language, or some other name, software should be interpreted broadly to mean instruction, instruction set, code, code segment, program code, program, subprogram, software module, application, software application, software package, routine, subroutine, object, executable file, execution thread, procedure, function, and the like.

Further, software, instruction, information, and the like may be transmitted and received via a transmission medium. For example, when a software is transmitted from a website, a server, or some other remote source by using at least one of a wired technology (coaxial cable, fiber optic cable, twisted pair, Digital Subscriber Line (DSL), or the like) and a wireless technology (infrared light, microwave, or the like), then at least one of these wired and wireless technologies is included within the definition of the transmission medium.

Information, signals, or the like mentioned above may be represented by using any of a variety of different technologies. For example, data, instruction, command, information, signal, bit, symbol, chip, or the like that may be mentioned throughout the above description may be represented by voltage, current, electromagnetic wave, magnetic field or magnetic particle, optical field or photons, or a desired combination thereof.

It should be noted that the terms described in this disclosure and terms necessary for understanding the present disclosure may be replaced by terms having the same or similar meanings. For example, at least one of the channels and symbols may be a signal (signaling). The signal may also be a message. Also, a signal may be a message. Further, a component carrier (Component Carrier: CC) may be referred to as a carrier frequency, a cell, a frequency carrier, or the like.

The terms “system” and “network” used in the present disclosure can be used interchangeably.

Furthermore, the information, the parameter, and the like explained in the present disclosure can be represented by an absolute value, can be expressed as a relative value from a predetermined value, or can be represented by corresponding other information. For example, the radio resource can be indicated by an index.

The name used for the above parameter is not a restrictive name in any respect. In addition, formulas and the like using these parameters may be different from those explicitly disclosed in the present disclosure. Because the various channels (for example, PUCCH, PDCCH, or the like) and information element can be identified by any suitable name, the various names assigned to these various channels and information elements shall not be restricted in any way.

In the present disclosure, it is assumed that “base station (Base Station: BS),” “radio base station,” “fixed station,” “NodeB,” “eNodeB (eNB),” “gNodeB (gNB),” “access point,” “transmission point,” “reception point,” “transmission/reception point,” “cell,” “sector,” “cell group,” “carrier,” “component carrier,” and the like can be used interchangeably. The base station may also be referred to with the terms such as a macro cell, a small cell, a femtocell, or a pico cell.

The base station can accommodate one or more (for example, three) cells (also called sectors). In a configuration in which the base station accommodates a plurality of cells, the entire coverage area of the base station can be divided into a plurality of smaller areas. In each such a smaller area, communication service can be provided by a base station subsystem (for example, a small base station for indoor use (Remote Radio Head: RRH)).

The term “cell” or “sector” refers to a part or all of the coverage area of a base station and/or a base station subsystem that performs communication service in this coverage.

In the present disclosure, the terms “mobile station (Mobile Station: MS),” “user terminal,” “user equipment (User Equipment: UE),” “terminal” and the like can be used interchangeably.

The mobile station is called by the persons skilled in the art as a subscriber station, a mobile unit, a subscriber unit, a radio unit, a remote unit, a mobile device, a radio device, a radio communication device, a remote device, a mobile subscriber station, an access terminal, a mobile terminal, a radio terminal, a remote terminal, a handset, a user agent, a mobile client, a client, or with some other suitable term.

At least one of a base station and a mobile station may be called a transmitting device, a receiving device, a communication device, or the like. Note that, at least one of a base station and a mobile station may be a device mounted on a moving body, a moving body itself, or the like. The mobile may be a vehicle (For example, cars, planes, etc.), an unmanned mobile (For example, drones, self-driving cars,), or a robot (manned or unmanned). At least one of a base station and a mobile station can be a device that does not necessarily move during the communication operation. For example, at least one of a base station and a mobile station may be an Internet of Things (IoT) device such as a sensor.

The base station in the present disclosure may be read as a mobile station (user terminal, hereinafter the s same). For example, each aspect/embodiment of the present disclosure may be applied to a configuration in which communication between a base station and a mobile station is replaced by communication between a plurality of mobile stations (For example, it may be called device-to-device (D2D), vehicle-to-everything (V2X), etc.). In this case, the mobile station may have the function of the base station. Further, words such as “up” and “down” may be replaced with words corresponding to communication between terminals (For example, “side”). For example, terms an uplink channel, a downlink channel, or the like may be read as a side channel.

Similarly, the mobile station in the present disclosure may be replaced with a base s station. In this case, the base station may have the function of the mobile station. A radio frame may be composed of one or more frames in the time domain. Each frame or frames in the time domain may be referred to as a subframe. A subframe may be further configured by one or more slots in the time domain. The subframe may be a fixed time length (For example, 1 ms) independent of numerology.

Numerology may be a communication parameter applied to at least one of transmission and reception of a certain signal or channel. The numerology can include one among, for example, subcarrier spacing (SubCarrier Spacing: SCS), bandwidth, symbol length, cyclic prefix length, transmission time interval (Transmission Time Interval: TTI), number of symbols per TTI, radio frame configuration, a specific filtering process performed by a transceiver in the frequency domain, a specific windowing process performed by a transceiver in the time domain, and the like.

The slot may be configured with one or a plurality of symbols (Orthogonal Frequency Division Multiplexing (OFDM)) symbols, Single Carrier Frequency Division Multiple Access (SC-FDMA) symbols, etc.) in the time domain. A slot may be a unit of time based on the numerology.

A slot may include a plurality of minislots. Each minislot may be configured with one or more symbols in the time domain. A minislot may also be called a subslot. A minislot may be composed of fewer symbols than slots. PDSCH (or PUSCH) transmitted in units of time greater than the minislot may be referred to as PDSCH (or PUSCH) mapping type A. PDSCH (or PUSCH) transmitted using a minislot may be referred to as PDSCH (or PUSCH) mapping type B.

Each of the radio frame, subframe, slot, minislot, and symbol represents a time unit for transmitting a signal. Different names may be used for the radio frame, subframe, slot, minislot, and symbol.

For example, one subframe may be called a transmission time interval (TTI), a plurality of consecutive subframes may be called TTI, and one slot or one minislot may be called TTI. That is, at least one of the subframes and TTI may be a subframe in an existing LTE (1 ms), a period shorter than 1 ms (For example, 1-13 symbols), or a period longer than 1 ms. Note that, a unit representing TTI may be called a slot, a minislot, or the like instead of a subframe.

Here, TTI refers to the minimum time unit of scheduling in radio communication, for example. Here, TTI refers to the minimum time unit of scheduling in radio communication, for example. For example, in the LTE system, the base station performs scheduling for allocating radio resources (frequency bandwidth, transmission power, etc. that can be used in each user terminal) to each user terminal in units of TTI. The definition of TTI is not limited to this.

The TTI may be a transmission time unit such as a channel-encoded data packet (transport block), a code block, or a code word, or may be a processing unit such as scheduling or link adaptation. When TTI is given, a time interval (for example, the number of symbols) in which a transport block, a code block, a code word, etc. are actually mapped may be shorter than TTI.

When one slot or one minislot is called TTI, one or more TTIs (that is, one or more slots or one or more minislots) may be the minimum scheduling unit. The number of slots (number of minislots) constituting the minimum time unit of the scheduling may be controlled.

TTI having a time length of 1 ms may be referred to as an ordinary TTI (TTI in LTE Rel. 8-12), a normal TTI, a long TTI, a normal subframe, a normal subframe, a long subframe, a slot, and the like. TTI shorter than the ordinary TTI may be referred to as a shortened TTI, a short TTI, a partial TTI (partial or fractional TTI), a shortened subframe, a short subframe, a minislot, a subslot, a slot, and the like.

In addition, a long TTI (for example, ordinary TTI, subframe, etc.) may be read as TTI having a time length exceeding 1 ms, and a short TTI (for example, shortened TTI) may be read as TTI having TTI length of less than the TTI length of the long TTI but TTI length of 1 ms or more.

The resource block (RB) is a resource allocation unit in the time domain and frequency domain, and may include one or a plurality of continuous subcarriers in the frequency domain. The number of subcarriers included in RB may be, for example, twelve, and the same regardless of the topology. The number of subcarriers included in the RB may be determined based on the neurology.

Also, the time domain of RB may include one or a plurality of symbols, and may have a length of 1 slot, 1 minislot, 1 subframe, or 1 TTI. Each TTI, subframe, etc. may be composed of one or more resource blocks.

Note that, one or more RBs may be called a physical resource block (Physical RB: PRB), a subcarrier group (Sub-Carrier Group: SCG), a resource element group (Resource Element Group: REG), PRB pair, RB pair, etc.

A resource block may be configured by one or a plurality of resource elements (Resource Element: RE). For example, one RE may be a radio resource area of one subcarrier and one symbol.

A bandwidth part (BWP) (which may be called a partial bandwidth, etc.) may represent a subset of contiguous common resource blocks (RBs) for a certain neurology in a certain carrier. Here, the common RB may be specified by an index of the RB relative to the common reference point of the carrier. PRB may be defined in BWP and numbered within that BWP.

BWP may include UL BWP (UL BWP) and DL BWP (DL BWP). One or a plurality of BWPs may be configured in one carrier for the UE.

At least one of the configured BWPs may be active, and the UE may not expect to transmit and receive certain signals/channels outside the active BWP. Note that “cell,” “carrier,” and the like in this disclosure may be read as “BWP.”

The above-described structures such as a radio frame, subframe, slot, minislot, and symbol are merely examples. For example, the number of subframes included in a radio frame, the number of slots per subframe or radio frame, the number of minislots included in a slot, the number of symbols and RBs included in a slot or minislot, the subcarriers included in RBs, and the number of symbols included in TTI, a symbol length, the cyclic prefix (CP) length, and the like can be changed in various manner.

The terms “connected,” “coupled,” or any variations thereof, mean any direct or indirect connection or coupling between two or more elements. Also, one or more intermediate elements may be present between two elements that are “connected” or “coupled” to each other. The coupling or connection between the elements may be physical, logical, or a combination thereof. For example, “connection” may be read as “access.” In the present disclosure, two elements can be “connected” or “coupled” to each other by using one or more wires, cables, printed electrical connections, and as some non-limiting and non-exhaustive examples, by using electromagnetic energy having wavelengths in the microwave region and light (both visible and invisible) regions, and the like.

The reference signal may be abbreviated as Reference Signal (RS) and may be called pilot (Pilot) according to applicable standards.

As used in the present disclosure, the phrase “based on” does not mean “based only on” unless explicitly stated otherwise. In other words, the phrase “based on” means both “based only on” and “based at least on.”

The “means” in the configuration of each apparatus may be replaced with “unit,” “circuit,” “device,” and the like.

Any reference to an element using a designation such as “first,” “second,” and the like used in the present disclosure generally does not limit the amount or order of those elements. Such designations can be used in the present disclosure as a convenient way to distinguish between two or more elements. Thus, the reference to the first and second elements does not imply that only two elements can be adopted, or that the first element must precede the second element in some or the other manner.

In the present disclosure, the used terms “include,” “including,” and variants thereof are intended to be inclusive in a manner similar to the term “comprising.” Furthermore, the term “or” used in the present disclosure is intended not to be an exclusive disjunction.

Throughout this disclosure, for example, during translation, if articles such as a, an, and the in English are added, in this disclosure, these articles shall include plurality of nouns following these articles.

As used in this disclosure, the terms “determining,” “judging” and “deciding” may encompass a wide variety of actions. “Judgment” and “decision” includes judging or deciding by, for example, judging, calculating, computing, processing, deriving, investigating, looking up, search, inquiry (e.g., searching in a table, database, or other data structure), ascertaining, and the like. In addition, “judgment” and “decision” can include judging or deciding by receiving (for example, receiving information), transmitting (for example, transmitting information), input (input), output (output), and access (accessing) (e.g., accessing data in a memory). In addition, “judgement” and “decision” can include judging or deciding by resolving, selecting, choosing, establishing, and comparing. In other words, “judgment” and “decision” may include regarding some action as “judgment” and “decision.” Moreover, “judgment (decision)” may be read as “assuming,” “expecting,” “considering,” and the like.

In the present disclosure, the term “A and B are different” may mean “A and B are different from each other.” It should be noted that the term may mean “A and B are each different from C.” Terms such as “leave,” “coupled,” or the like may also be interpreted in the same manner as “different.”

FIG. 9 shows a configuration example of a vehicle 2001. As shown in FIG. 9, the vehicle 2001 includes a drive unit 2002, a steering unit 2003, an accelerator pedal 2004, a brake pedal 2005, a shift lever 2006, left and right front wheels 2007, left and right rear wheels 2008, an axle 2009, an electronic control unit 2010, various sensors 2021 ˜2029, an information service unit 2012, and a communication module 2013.

The drive unit 2002 is composed of, for example, an engine, a motor, and an engine-motor hybrid. The steering unit 2003 includes at least a steering wheel and is configured to steer at least one of the front and rear wheels based on the operation of the steering wheel operated by the user. The electronic control unit 2010 consists of a microprocessor 2031, a memory (ROM, RAM) 2032 and communication ports (IO ports) 2033. The electronic control unit 2010 receives signals from various sensors 2021˜2027 provided in the vehicle. The electronic control unit 2010 may be referred to as an ECU (Electronic Control Unit).

The signals from the various sensors 2021˜2028 include a current signal from a current sensor 2021 for sensing the current of a motor, a speed signal of a front wheel and a rear wheel acquired by an rpm sensor 2022, a pressure signal of a front wheel and a rear wheel acquired by an air pressure sensor 2023, a speed signal of a vehicle acquired by a speed sensor 2024, an acceleration signal acquired by an acceleration sensor 2025, an accelerator pedal depressing amount signal acquired by an accelerator pedal sensor 2029, a brake pedal depressing amount signal acquired by a brake pedal sensor 2026, an operation signal of the shift lever acquired by a shift lever sensor 2027, and a detection signal acquired by an object detection sensor 2028 for detecting obstacles, vehicles, pedestrians, and the like.

The information service unit 2012 comprises various devices such as a car navigation system, an audio system, a speaker, a television, and a radio for providing various information such as driving information, traffic information, and entertainment information, and one or more ECUs for controlling these devices. The information service unit 2012 provides various multimedia information and multimedia services to the occupants of the vehicle 2001 by utilizing information acquired from an external device via the communication module 2013 or the like.

A driver assistance system unit 2030 consists of various devices, such as millimeter-wave radar, LiDAR (Light Detection and Ranging), camera, positioning locator (e.g. GNSS), map information (e.g. high-definition (HD) maps, self-driving car (AV) maps, etc.), gyro system (e.g. IMU (Inertial Measurement Unit), INS (Inertial Navigation System), etc.), AI (Artificial Intelligence) chip, AI processor, which are used to provide functions to prevent accidents or reduce the driver's driving load, and one or more ECUs that control these devices. The driver assistance system unit 2030 also transmits and receives various information via the communication module 2013 to realize a driver assistance function or an automatic driving function.

The communication module 2013 can communicate with the microprocessor 2031 and components of the vehicle 2001 via a communication port. For example, the communication module 2013 transmits and receives data via the communication port 2033 to and from the microprocessor 2031, the memory (ROM, RAM) 2032, and the sensors 2021˜2028 in the drive unit 2002, the steering unit 2003, the accelerator pedal 2004, the brake pedal 2005, the shift lever 2006, the left and right front wheels 2007, the left and right rear wheels 2008, the axle 2009, and the electronic control unit 2010 in the vehicle 2001.

The communication module 2013 is a communication device that can be controlled by the microprocessor 2031 of the electronic control unit 2010 and can communicate with external devices. For example, it transmits and receives various information to and from external devices via radio communication. The communication module 2013 may be either inside or outside the electronic control unit 2010. The external device may be, for example, a base station, a mobile station, etc.

The communication module 2013 transmits a current signal from a current sensor input to the electronic control unit 2010 to an external device via radio communication. The communication module 2013 also transmits, via radio communication, to an external device the speed signals of the front and rear wheels acquired by the rpm sensor 2022, the air pressure signals of the front and rear wheels acquired by the air pressure sensor 2023, the vehicle speed signals acquired by the vehicle speed sensor 2024, the acceleration signals acquired by the acceleration sensor 2025, the accelerator pedal depressing amount signals acquired by the accelerator pedal sensor 2029, the brake pedal depressing amount signals acquired by the brake pedal sensor 2026, the shift lever operation signals acquired by the shift lever sensor 2027, and the detection signals acquired by the object detection sensor 2028 for detecting obstacles, vehicles, pedestrians, etc., which are inputted to the electronic control unit 2010.

The communication module 2013 receives various kinds of information (traffic information, signal information, Inter-vehicular distance information, etc.) transmitted from an external device and displays them to the information service unit 2012 provided in the vehicle. The communication module 2013 also stores various information received from external devices in the memory 2032 available by the microprocessor 2031. Based on the information stored in the memory 2032, the microprocessor 2031 may the control drive unit 2002, the steering unit 2003, the accelerator pedal 2004, the brake pedal 2005, the shift lever 2006, the left and right front wheels 2007, the left and right rear wheels 2008, the axle 2009, the sensors 2021˜2028, etc. provided in the vehicle 2001.

Although the present disclosure has been described in detail above, it will be obvious to those skilled in the art that the present disclosure is not limited to the embodiments described in this disclosure. The present disclosure can be implemented as modifications and variations without departing from the spirit and scope of the present disclosure as defined by the claims. Therefore, the description of the present disclosure is for the purpose of illustration, and does not have any restrictive meaning to the present disclosure.

### EXPLANATION OF REFERENCE NUMERALS

10 radio communication system
20 NG-RAN
100 gNB
200 UE
210 radio signal transmission and reception unit
220 amplifier unit
230 modulation and demodulation unit
240 control signal and reference signal processing unit
250 encoding/decoding unit
260 data transmission and reception unit
270 control unit
1001 processor
1002 memory
1003 storage
1004 communication device
1005 input device
1006 output device
1007 bus
2001 vehicle
2002 drive unit
2003 steering unit
2004 accelerator pedal
2005 brake pedal
2006 shift lever
2007 left and right front wheels
2008 left and right rear wheels
2009 axle
2010 electronic control unit
2012 information service unit
2013 communication module
2021 current sensor
2022 rpm sensor
2023 air pressure sensor
2024 speed sensor
2025 acceleration sensor
2026 brake pedal sensor
2027 shift lever sensor
2028 object detection sensor
2029 accelerator pedal sensor
2030 driver assistance system unit
2031 microprocessor
2032 memory (ROM, RAM)
2033 communication port

1. A terminal comprising:
a transmission unit that transmits a plurality of uplink data channels scheduled by a single downlink control information; and
a control unit that assumes that if any of the uplink data channels collides with a downlink symbol, the uplink data channel canceled by the collision is excluded from the specified scheduling.

2. A terminal comprising:
a transmission unit that transmits a plurality of uplink data channels scheduled by a single downlink control information; and
a control unit that determines reporting of channel status information based on the scheduled uplink data channel or the valid uplink data channel.

3. A terminal comprising:
a transmission unit that transmits a plurality of uplink data channels scheduled by a single downlink control information; and
a control unit that determines presence or absence of information on a code block group based on the scheduled uplink data channel or the valid uplink data channel.

4. A terminal comprising:
a transmission unit that transmits a plurality of uplink data channels scheduled by a single downlink control information; and
a control unit that, if any of the uplink data channels collides with a downlink symbol, stops transmitting the uplink data channels with a configured grant canceled by the collision.

5. A radio communication system including a radio base station and a terminal,
wherein the terminal comprises:
a transmission unit that transmits a plurality of uplink data channels scheduled by a single downlink control information; and
a control unit that assumes that if any of the uplink data channels collides with a downlink symbol, the uplink data channel canceled by the collision is excluded from the specified scheduling, and
the radio base station comprises a reception unit that receives the plurality of uplink data channels.

6. A radio communication method comprising the steps of:
transmitting, by a radio base station, a plurality of uplink data channels scheduled by a single downlink control information;
transmitting, by a terminal, a plurality of uplink data channels scheduled by a single downlink control information;
assuming, by the terminal, that if any of the uplink data channels collides with a downlink symbol, the uplink data channel canceled by the collision is excluded from the specified scheduling; and
receiving, by a radio base station, the plurality of uplink data channels.
